(19) United States
(12) Patent Application Publication
(10) Pub. No.: US 2006/0058144 A1
(43) Pub. Date: Mar. 16, 2006

(54) System for lubricating a rivetless chain

(76) Inventor: Mario Lacerda, Tampa, FL (US)

Correspondence Address: Amy Lachman, 75 N Pioneer Blvd., Springboro, OH, 45066, US

(21) Appl. No.: 11/169,959

(22) Filed: Jun. 30, 2005

Related U.S. Application Data
(60) Provisional application No. 60/585,989, filed on Jul. 7, 2004.

(51) Int. Cl. F16G 13/02; F16G 15/00

(52) U.S. Cl. 474/224; 474/233; 474/225

(57) ABSTRACT

The pin and center link of the invention is used in a rivetless chain. It is manufactured to contain a reservoir to receive a lubricant. The reservoir may be in the form of a hole or a groove of various configurations. The lubricant is inserted into the pin or center link to provide lubrication to the center link/pin interface for extending the life of the chain. The size and location of the reservoir are selected to optimize the overall balance between load bearing strength and lubricant surface area at the center link/pin interface. The lubrication system of the present invention will also prevent leakage of lubricant onto the product and provide a clean environment.

### RELATED APPLICATION

This patent application is based on and claims priority of provisional patent application No. 60/585989, filed on Jul. 7, 2004.

### BACKGROUND OF THE INVENTION

The present invention relates to a rivetless conveyor chain, and more specifically, to a lubrication system for the pins that connect the adjacent links of the rivetless conveyor chain.

The original rivetless chain was the subject of U.S. Pat. No. 870,704, Nov. 12, 1907, to Weston. The chain, which is invariably referred to as “keystone”, “rivetless” or “Weston” chain, had wide application in conveyor, mining machinery and other industrial uses. Rivetless chain is strong, adaptable as a sprocket chain and subject to lengthening or shortening by adding or removing individual links to the chain.

Generally speaking, rivetless chains consist of alternating units of center links and pairs of side bars joined together by headed pins. Each center link consists of an individual piece of metal having a pair of laterally spaced sidewalls joined at their end by curved end walls. The sidewalls and end walls enclose or surround an elongated slot. A pair of sidebars, each having an elongated slot at each end, is pivotally connected to each end of each center link by headed pins, each pin having a transverse head on each end thereof similar to the headed end of a “T” head machine bolt. The sidebars are formed at their ends with transversely extending recesses on their outer faces in which the heads of the pins are seated to lock the pin in position after the center links and sidebars have been coupled together. Each of the center links has a narrow central portion which tapers outwardly adjacent to the ends of the link to form thickened portions at the link ends. When the center links and sidebars are assembled by means of the headed pins to form a chain, its sidebars and center links are arranged in an alternate relationship along the chain, each center link connected to each end thereof a pair of face sidebars and each such pair of sidebars being connected at each end to an adjacent center link and so that pivotal movement is permitted between the adjacent center links and side bars about the center of the headed pin used as an axis. An improved rivetless chain is disclosed in U.S. Pat. No. 2,507,025, May 9, 1950, to Lemmon, which is directed to a center link for rivetless chains having thickened end portions with convexly curved upper and lower faces and a central portion, the upper and lower faces of which are also convexly curved, the curved end portions and central portion of the link being connected by reentrance concave surfaces which merge gradually with the end and central portions without the formation of any sharp lines or demarcation or cleavage. The improved center links set forth in the Lemmon patent are commonly used today, and the present invention is particularly well adapted to be associated with rivetless chains having such improved center links.

The specifications of both the aforementioned Weston and Lemmon patents are specifically incorporated by reference herein.

To extend the life of the chain, increase durability and provide a smoother running conveyor chain, it is desirable to lubricate the connector pin bodies at each link junction. Automatic lubrication systems for chain pins are commercially available. One such device is sold under the trademark “Lubtronics”. This type of lubricator provides lubricant at the pin area between adjacent connected links. However, due to the convexity and flatness of the Lemmon and Weston center links at the connector pin junctions, the lubricant generally rolls off the outside surface of the links and does not lubricate the pin. Thus, it is desirable to have a mechanism which is associated with the links which provides the connector pin bodies with lubricant.

A chain lubricating system is disclosed in U.S. Pat. No. 5,078,654, Jan. 7, 1992 to Naz. In this invention, a reservoir is incorporated into the curved center link which is designed to receive a desired amount of liquid lubrication and distribute it to the connector pins. The reservoir is usually incorporated into the curved end wall portion of the link. The problem with this approach is that an inadequate seal is formed around the reservoir between the link and the pin resulting in the liquid lubricant dripping out of the reservoir causing safety and housekeeping problems and reducing the effectiveness of the lubricant.

U.S. Pat. No. 5,257,690 (Clarence A. Dehne) relates to conveyor chains wherein the pins are provided with lubrication grooves. The grooves extend from the T-head ends of the pin to lubricate the central portion of the pin. Preferably the grooves are not perpendicular to the ends. The difficulty in using a pin of this design is that the lubrication is not held in the groove and is applied through the ends of the pin using an enlarged groove mouth to allow the lubricant to enter the groove more easily. Leakage of lubrication causes a problem with oil dripping on the product. For applications like paint lines and packaging operations, oil dripping onto the product cannot be tolerated. The pin with the groove extending to the head of the pin is also not designed for strength. The groove design and location taught in this patent will lower the strength of the pin.

Accordingly, it is an object of the present invention to provide improved lubrication to the center link/pin interface of a rivetless conveyor chain. The present invention provides a chain with lubricant incorporated into a reservoir formed in the pin or center link of the chain. The lubricant spreads across the interface between the pin and the mating link. The design of the reservoir and type of lubricant will provide the desired balance of pin strength and improved lubrication.

From the following detailed description taken in conjunction with the accompanying drawings and subjoined claims, other objects and advantages of the present invention will become apparent to those skilled in the art.

### BRIEF DESCRIPTION OF DRAWINGS

FIG. 1 is an isometric view of a small length of rivetless chain.

FIG. 2 is a cross sectional view of FIG. 1 taken along plane 2-2.

FIG. 3 is an exploded isometric view of a pin of the present invention showing the solid lubricant and the slot where it is to be inserted.

FIG. 4 is an exploded isometric view of a pin of the present invention showing holes instead of the groove.

FIG. 5 is an exploded isometric view of the end of the center link showing the use of a reservoir in the center link.

FIG. 6a is a photograph of a pin not of the invention showing the wear after about 8 months of use.

FIG. 6b is a photograph of a pin of the invention showing the greatly reduced wear after 16 months resulting from the improved lubrication.

### DETAILED DESCRIPTION OF THE PREFERRED EMBODIMENT

In the present invention, a pin for a rivetless chain is manufactured with a reservoir(s) containing lubricants to provide improved lubrication. The reservoir(s) which may be in the form of a groove(s) or hole(s) is provided to hold the lubricant in the proper position. The lubricant is held in place in one or more grooves or one or more holes provided in the pin by a close spacing relationship between the reservoir and the lubricant block dimensions. Adhesives on the bottom or sidewalls of the reservoir may provide improved lubricant adherence in the reservoir. The lubricant will provide desired lubrication at the interface between the pin and the center link, without the undesirable dripping of oil. This lubricant can be manufactured from microporous polymeric lubricant (MPL), graphite, MoS₂, grease, solid grease, impregnated polymers, sponge, sintered bronze, impregnated felt, polytetrafluorene (PTFE), ultra high molecular weight polyethylene (UHMWPE) and various other lubricants. Solid lubricants are generally preferred and microporous polymeric lubricants have proven to be very successful. Typically, solid lubricants have more than 30% solids and will remain in the reservoir longer when compared to oil and conventional greases. The lubricant will spread out from the reservoir and will reduce the friction and wear at the interface of the center link and pin. The rubbing action at the interface of the center link and pin will tend to help distribute the lubricant as will the surface tension between the lubricant and the pin surface.

The reservoir can be formed into the pin either during the forging operation of the pin or during a separate step such as machining, etching or laser cutting and the like. A number of cross-sectional reservoir and solid lubricant shapes can be employed.

The lubrication of the rivetless chain may also be accomplished by inserting lubricant into the center link. Lubrication at the center link/pin interface could also be provided using a reservoir in the form of a groove(s) or hole(s) in the link in various arrays. Preferably microporous lubricants are inserted into the reservoir(s) and will, by surface tension effects, spread the lubricant over the high-energy metal surfaces. The center link reservoirs may be of any shape as in the pin reservoirs and generally will be less than about 50%, and typically about 5% to about 30% of the wear surface area. There is an inverse relationship between the strength of the pin and the reservoir volume. The present invention allows one to change the volume of the reservoir and, thus, the strength of the pin to tailor the properties for the specific chain requirements.

The surface area of the reservoir and the volume of the cavity holding the lubricant determine the amount of lubricant and service life provided to the pins. The lubricant surface area will generally be less than about 50% and typically between about 5% to about 30% of the surface area where wear could occur. The shape of the reservoir may vary depending on the method of manufacture. For example, forging a groove will normally provide a tapered opening which is wider at the surface which provides a trough shape. Machining will typically produce a more rectangular shaped groove with less slope on the sidewall. If one were to use a laser or electro-discharge machining (EDM) to provide the groove, the shape could be more trapezoidal which would better hold the solid lubricant into place but would be more expensive to produce. Adhesive materials could also be used at the bottom of the reservoir to hold the lubricant in place. The reservoir will typically be formed based on the ease and cost of manufacture. The position and orientation of the reservoir along the pin may be varied to optimize lubrication and maximize the load bearing surface and its location. The reservoir could be wrapped around, helical, or spiral around the pin.

As wear of the pin occurs, the load bearing capacity of the pin is reduced and the pin must eventually be replaced. The magnitude of the shearing forces and bending forces also influence the life of the pin. The load bearing capabilities of the pin will decrease as wear occurs. The strength of the pin is always an important consideration in determining when the pin must be replaced. The shear planes will shift according to the spacing between the pin, sidebars and center link. Shear planes will vary depending on the manufacturing design and spacing between the link and pin. The shear plane is between the sidebars and the center link. This is different from the surface wear area which is where the pin contacts the center link.

The reservoir could be provided on opposite sides of the pin to simplify installation of the lubricant and insure lubrication will be applied to the chain.

In order to reduce manufacturing costs, it is preferred to simplify the manufacturing and add as few additional steps as possible. Forging the pins requires the consideration of one or two steps and this is also related to the number of reservoirs and their location. If forging is used, the alignment of the reservoirs simplifies the forging operation. The reservoir will lower the overall strength slightly but as shown later in the table, the reservoir does not cause a significant reduction in strength. Reservoirs should be long enough to lubricate the area that wear takes place in the chain. The depth of the reservoir is determined based on providing the optimum volume of lubricant. The reduction in cross sectional area of the pin by wear exceeds the cross sectional area reduction caused by reservoirs.

The pins used in a rivetless chain meeting specification x678 require a strength of at least 444,800 Newtons (100,000 lbf) (load to failure) and the pins of the invention greatly exceed this limitation. Pins for lower or higher load applications may have the reservoir surface area adjusted for the required load chain. Obviously, the strength of the pin is influenced by the hardness, heat treatment, type of material, and method of manufacture.

It is important in the present invention that the reservoir does not extend to the head of the pin. If the manufacturing spacing between the pin and center link are known, the location of the reservoir may be selected to stay within the width of the surface wear area. When the reservoirs are outside the surface wear area, the wear conditions are not affected but the reservoir may have a negative influence on the strength of the pin. The amount of metal in the surface wear area vs. the reservoir surface area will also slightly influence the overall strength of the pin. The forces acting on the pin are created by the center link and the sidebars pulling on the pin in opposite directions. These forces create a shearing action in the pin.

The reservoir creates stress risers. For maximum strength, it is important for the reservoir to not cross into the shear planes which reduces the shear area and, therefore, reduces the shear strength. Therefore, having the reservoir located in the middle of the pin and not extending into the pin head allows for the greatest shear strength.

The present invention will now be discussed in terms of the figures.

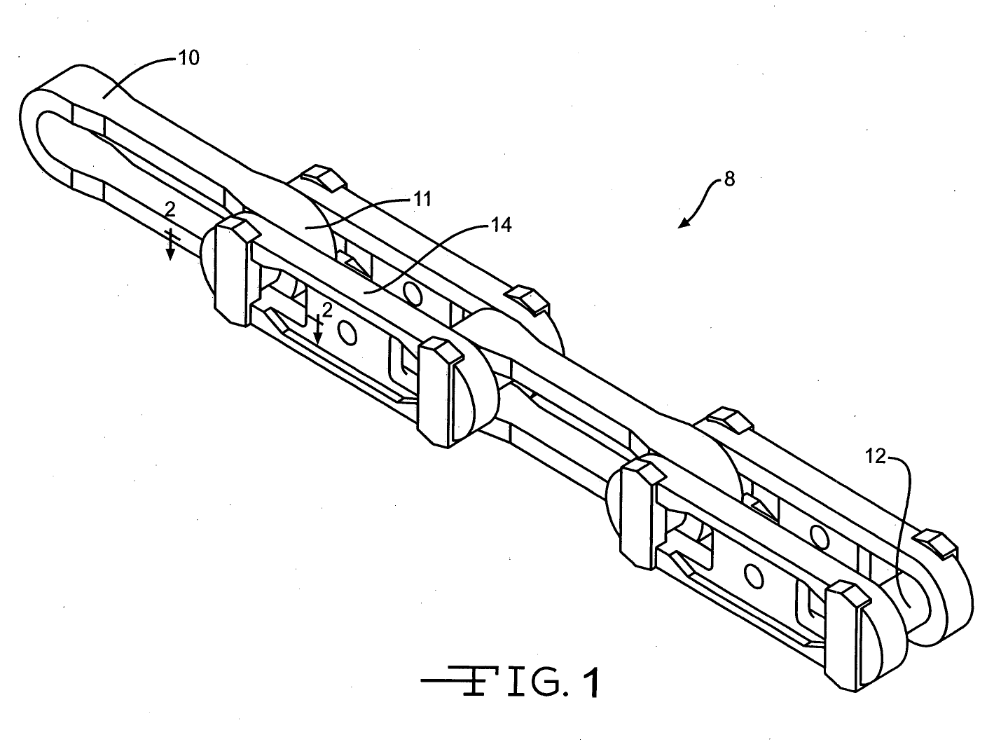

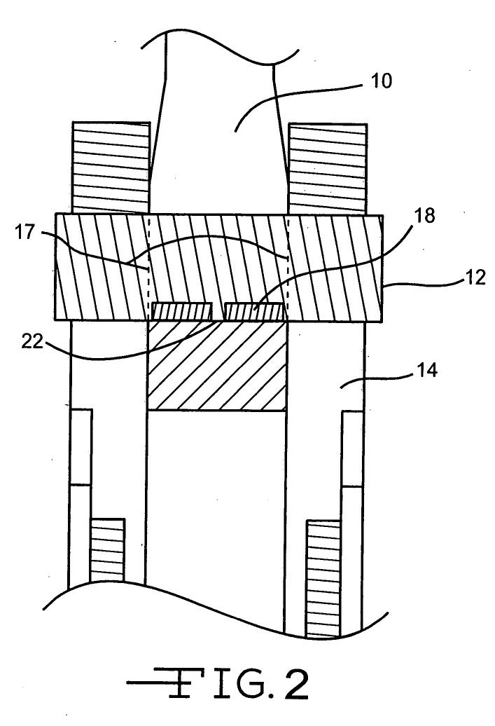

FIG. 1 shows an isometric drawing of a section of a rivetless conveyor chain 8. It consists of four major parts: the center link 10, the pin 12 and two sidebars 14. The purpose of the present invention is to provide lubrication at the center link/pin interface 22 between the center link 10 and the pin 12 as shown in FIG. 2.

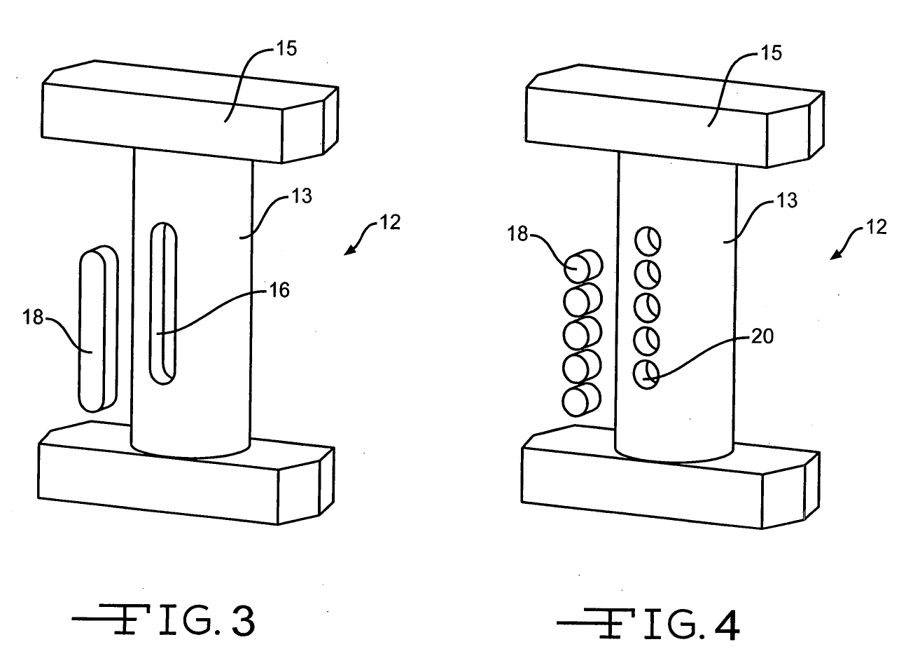

FIG. 3 shows an isometric exploded view of a pin 12 of the invention with groove 16 (reservoir) and lubricant 18 to be inserted into the groove 16. It is obvious that the size and shape of the lubricant 18 is matched with the size and shape of the groove 16 to insure a tight fit which holds the lubricant in place until the pin is installed in the chain. The volume of the groove 16 is determined, as previously mentioned, to provide a volume of lubricant 18 which provides a long service life but does not significantly detract from the overall strength of the pin 12. One or more grooves 16 could be used. One or more grooves 16 could also be placed on the opposite side of the pin 12 (not shown) to assure that the lubrication will be located at the center pin/link interface 22, regardless of how the pin is installed in the chain.

As shown in FIG. 4, several holes 20 (reservoirs) are provided in pin 12 and lubricant 18. The number, spacing and size of the holes 20 is selected to provide desired lubrication to the wear surface at the center link/pin interface 22 and the depth of the holes 20 is determined to supply the volume of lubricant required for service life just as with the groove 16. Round sections of the lubricant 18 are inserted into the holes 20.

A dramatic reduction in wear was found when pins 12 were provided with a solid lubricant 18 in holes 20 compared to pins not of this invention. In an actual test, five holes were drilled into the pin and cylindrical sections of microporous polymeric lubricant 6.4 mm in diameter and 6.4 mm long were inserted into the holes. The microporous polymeric lubricant employed in this test was MicroPoly® produced by PhyMet, Inc. Several chain pins containing MicroPoly were inserted into a conveyor chain being used to transport steel coils. In this test, the chain was examined periodically to determine the wear of the MicroPoly lubricated pins and compare it to standard pins. The results showed that the average wear rate of standard pins were 1.5 mm per month. On the other hand, the wear rate of the MicroPoly lubricated pins using the teachings of this invention was significantly less, 0.2 mm per month. Additionally, the standard pins typically failed in this application in 3 to 5 months as a result of excessive wear. The MicroPoly lubricated pin was in operation for 16 months.

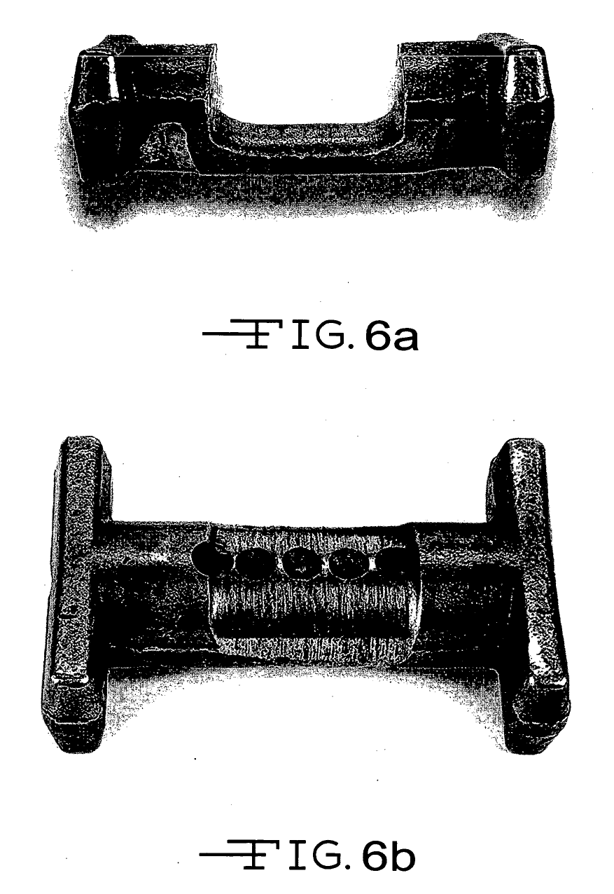

Photographs of the pins tested are shown in FIG. 6a (standard) after 8 months and FIG. 6b (5 holes of lubricants) after 16 months of operation. These photographs show the dramatic improvement resulting from the use of lubricated pins of the invention.

The strength of the pins having various slot designs were measured and are listed in Table 1 below. All of the pins were forged and in the hardened condition and the grooves had a depth of 6 mm. As can be seen the pins of the invention with various groove dimensions far exceeded the minimum strength requirement of a rivetless chain meeting specification x678, 444,800 N (100,000 lbf).

TABLE 1

| | | Spacing | | |
|---|---|---|---|---|
| | Number of | between slots | Slot Size | Load To Failure |
| ID | Slots | (mm) | (mm) | (Newtons) |
| 1 | 0 | — | No Slot | 614,700 |
| 2 | 2 | 10 | 6 × 10 | 620,100 |
| 3 | 2 | 5 | 6 × 10 | 560,500 |
| 4 | 1 | — | 6 × 30 | 596,100 |
| 5 | 1 | — | 6 × 15 | 589,800 |

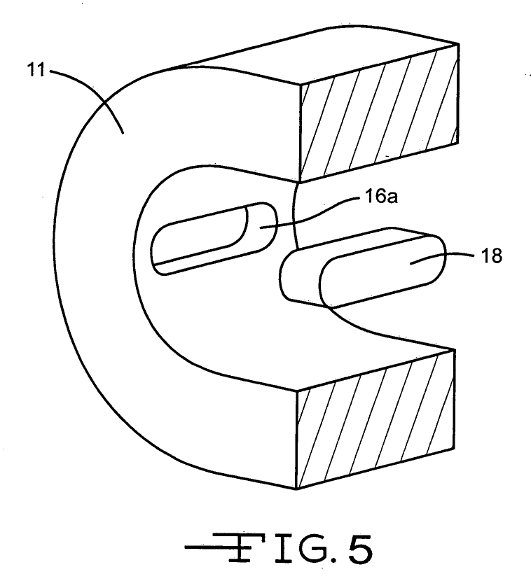

It is important that the pin containing the solid lubricant be inserted correctly into the chain. The lubricated side of the pin must be in the orientation so that it is in contact with the center link 10 as shown in FIG. 2. In this way, the solid lubricant is available to provide lubrication to the critical wear surfaces. The manufacturer may specify a reservoir on both sides of the pins to make sure when the pins are installed that lubrication to the center link/pin interface 22. As mentioned previously and as shown in FIG. 5, another option is to provide solid lubricants in the rounded ends of center links 10 but this would be more difficult to manufacture. The lubricant needs to extend over the friction area between the pin and the center link. The reservoir(s) should not extend to the edges of the center link. Various combinations of grooves and/or holes may be used to provide the improved lubrication.

It will be appreciated by those skilled in the art that numerous variations and additional embodiments not disclosed above are readily apparent. The above description should be understood to be illustrative and not in any way limiting. The scope of the present invention should be measured by the following claims.

I claim:

1. A rivetless chain having alternating units of elongated center links and pairs of elongated sidebars straddling ends of said center links joined together by and pivoting around connecting pins, the improvement comprising providing said pins with one or more reservoirs which do not extend to ends of said pins to hold lubricant at an interface between said pins and said elongated center links.

2. The chain of claim 1 wherein said lubricant is selected from the group consisting of microporous polymeric lubricant (MPL), graphite, Teflon, MoS₂, solid greases, impregnated polymers, sponge, sintered bronze, impregnated felt, PTFE, and UHMWPE.

3. The chain of claim 1 wherein said reservoir consists of one or more grooves for holding said lubricant of a similar shape.

4. The chain of claim 1 wherein said reservoir consists of one or more round holes for holding cylindrical sections of lubricant.

5. The chain of claim 1 wherein said reservoirs with said lubricants are provided on both sides of said pin.

6. A pin between center links in a rivetless chain, the improvement comprising providing lubricant in a reservoir which does not extend to ends of said pin to provide lubrication at an interface between said pin and said center links and also provide improved pin strength.

7. The pin of claim 6 wherein said reservoir consists of one or more grooves.

8. The pin of claim 6 wherein said reservoir consists of two aligned grooves.

9. The pin of claim 6 wherein said reservoir consists of one or more holes.

10. The pin of claim 6 wherein said lubricant is a solid lubricant.

11. The pin of claim 6 wherein said lubricant is selected from the group consisting of microporous polymeric lubricant (MPL), graphite, Teflon, MoS₂, solid grease, grease, impregnated polymers, sponge, sintered bronze, impregnated felt, PTFE, and UHMWPE.

12. The pin of claim 6 wherein a lubricant surface area of about 5% to about 30% is provided in said reservoir for an area of wear between said pin and said center links.

13. The pin of claim 6 wherein said reservoir has its volume adjusted to provide a desired pin strength.

14. A method of lubricating a pin in a center link of a rivetless chain whereby a reservoir in said pin, which does not extend to ends of said pin, is provided to optimize an overall balance between load bearing strength and lubricant surface area at an interface between said pin and said center link.

15. A center link lubrication system whereby a reservoir filled with solid lubricant, which does not extend to ends of said center link, is provided in said center link at an interface with a pin in a rivetless chain.
